(19) United States
(12) Patent Application Publication
(10) Pub. No.: US 2004/0246847 A1
(43) Pub. Date: Dec. 9, 2004

(54) Disk reproducing device

(75) Inventor: Shigehiro Yoshida, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 10/833,311

(22) Filed: Apr. 28, 2004

(30) Foreign Application Priority Data
Jun. 6, 2003 (JP) 2003-162620

(51) Int. Cl. G11B 7/00

(52) U.S. Cl. 369/53.2; 369/53.31

(57) ABSTRACT

A disk reproducing device includes: disk detecting part that detects whether or not a disk storing music data stored in a plurality of directories formed in hierarchical structure is inserted into a deck section; a microprocessor that determines whether or not an operation mode is a scanning search reproduction mode and generates an instruction to start scanning search reproduction of the disk inserted into the deck section for each directory when the operation mode is the scanning search reproduction mode; and reproducing means that selects a directory from the disk on the basis of the instruction from the microprocessor and reproduces a music file at the beginning of the directory for a short time.

### BACKGROUND OF THE INVENTION

1. Field of the Invention

The present invention relates to a disk reproducing device suitably used, for example, in a case of reproducing disks conforming to a file system of compressed audio signal (hereinafter refereed to as “compressed audio”) such as MP3 (MPEG-1 Audio Layer 3), WMA (Windows (trademark) Media Player) or the like, and in a case of reproducing compressed images accompanied by compressed sound signal.

2. Description of the Related Art

Usually, there is MP3 as one of typical compressed audio standards and by means of this MP3, a single disk can records files of music (hereinafter referred to as “music file”) 10 times as many as an ordinary CD. Whereas; a reproducing unit having no tree structure such as vehicle mounted reproducing unit of an ordinary 1DIN size needs some method capable of quickly selecting a target music at the time of reproduction.

Hence, there was proposed a device that extracts music files other than a music file now being reproduced and displays numbers of the music files, names of the such music, and the name of artist (at this point, the term “artist” means players and the like) of the extracted music files at predetermined intervals (for example, see patent document 1).

Moreover, there was proposed a device that searches music files to be reproduced in alphabetical order or in order of the date and time of recording to reproduce the selected music file (for example, see patent document 2).

[Patent document 1] Japanese Unexamined Patent Publication No. 2002-216462

[Patent document 1] Japanese Unexamined Patent Publication No. 2002-269954

However, the device disclosed in the above patent document 1 displays the number of music files, the name of music and the name of artist of a music file other than a music file now being reproduced at predetermined intervals, so users need to see its display one by one during driving, which presents a problem also from a safety standpoint in the case of a vehicle mounted unit.

Further, the device disclosed in the above patent document 2 searches a music file to be reproduced in alphabetical order or in order of the date and time of recording to reproduce the set music file and hence is an orthodox device. However, the device presents problems that the search of a music file needs a specific operation and a careful watch on a screen and that the search of a music file in order of the date and time of recording is hard to reach a target music file and takes much time.

### SUMMARY OF THE INVENTION

The present invention has been made to solve the above described problems. The object of the invention is to provide a disk reproducing device capable of reproducing music (music file) by a simple operation easily and speedily.

A disk reproducing device in accordance with the present invention includes: disk detecting means that detects whether or not a disk storing music data stored in a plurality of directories formed in hierarchical structure is inserted into a deck section; control means that determines whether or not an operation mode is a scanning search reproduction mode and generates an instruction to start scanning search reproduction of the disk inserted into the deck section for each directory when the operation mode is the scanning search reproduction mode; and reproducing means that selects a directory from the disk on the basis of the instruction from the control means and reproduces a music file at the beginning of directory for a short time.

Therefore, in accordance with the present invention, there is produced an effect that even in the case of a vehicle mounted unit with 1DIN size, the user can select and reproduce a target music file on a disk which conforms a file system of compressed audio by a simple operation with relative ease and speedily even without a careful watch on a display.

### BRIEF DESCRIPTION OF THE DRAWINGS

FIG. 1 is a system block diagram to show a disk reproducing device in accordance with embodiment 1 of the present invention.

FIG. 2 is a flow chart to show schematic operation of the disk reproducing device in accordance with embodiment 1 of the present invention.

FIG. 3 is a diagram to show a method to scan a hierarchy of directories in the disk reproducing device in accordance with embodiment 1 of the present invention.

FIG. 4 is a flow chart to show the detailed operation of a reproducing mode of the disk reproducing device in accordance with embodiment 1 of the present invention.

### DETAILED DESCRIPTION OF THE PREFERRED EMBODIMENT

Hereinafter, the preferred embodiment of the present invention will be described.

### EMBODIMENT 1

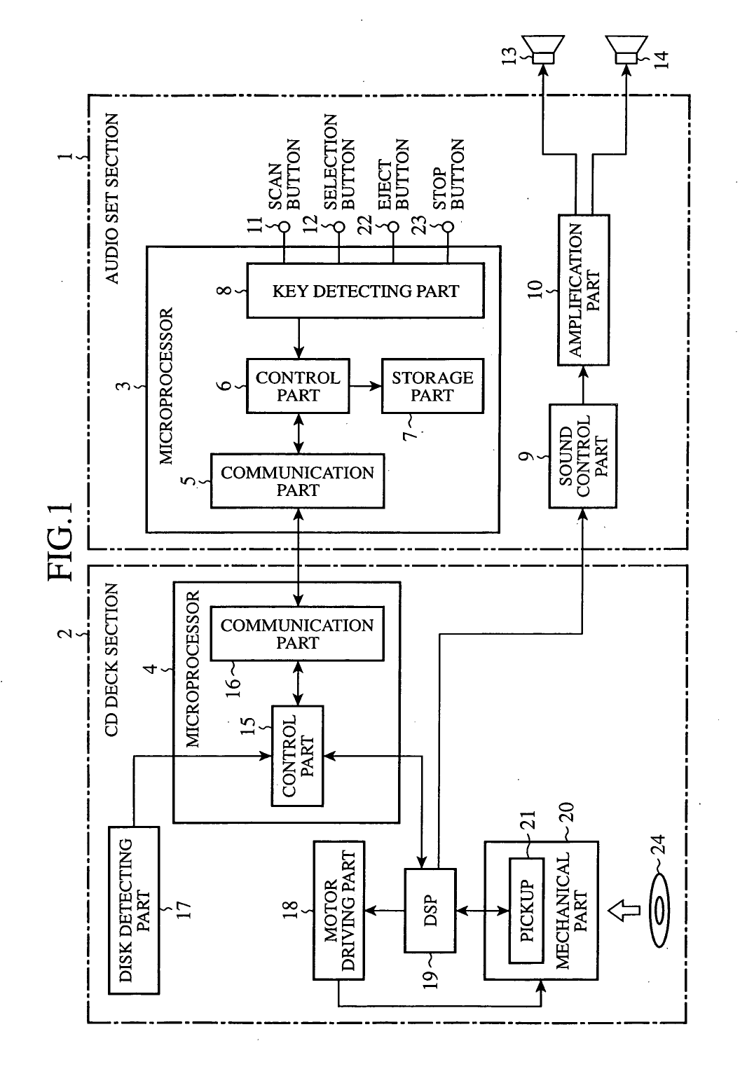

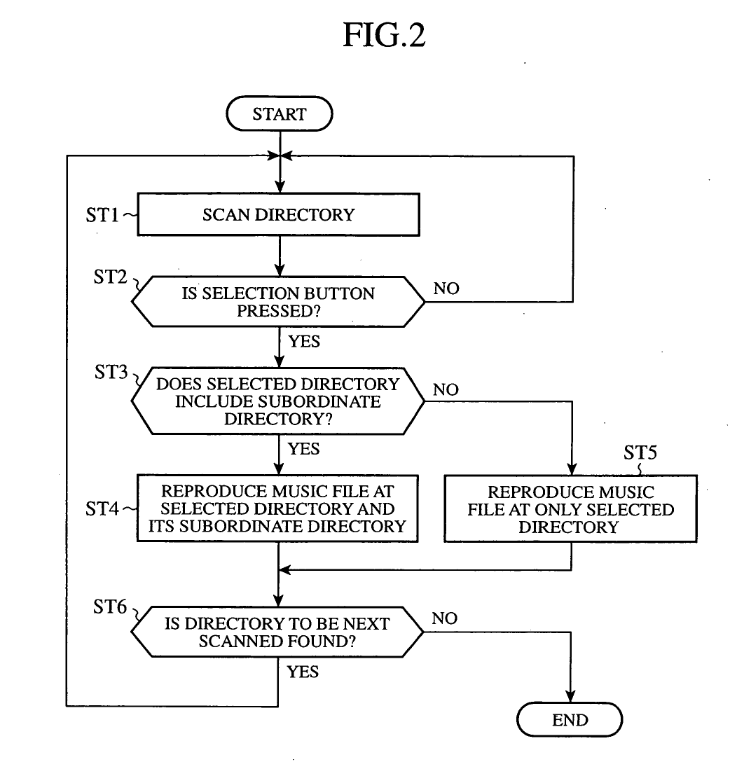

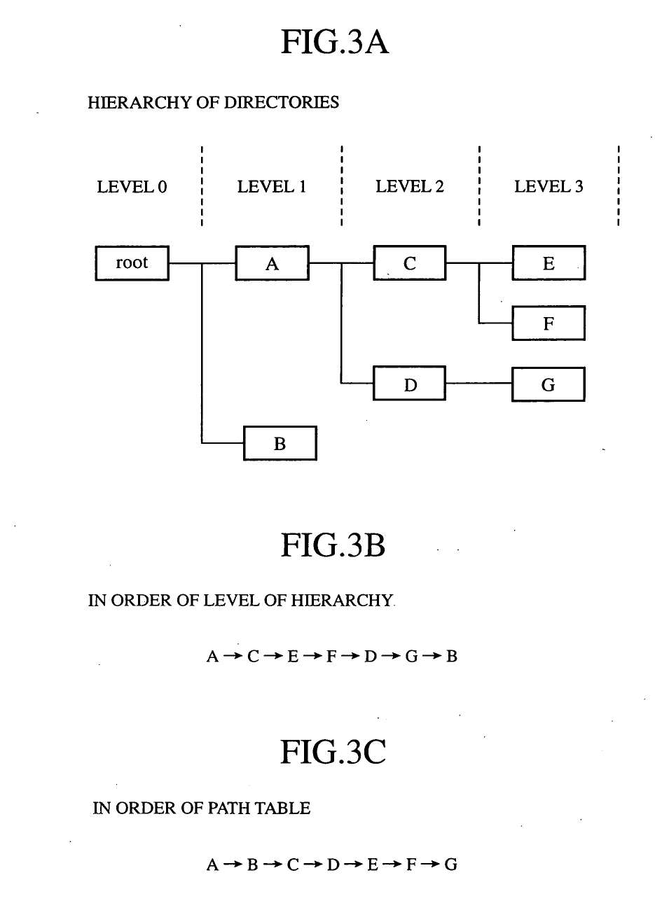

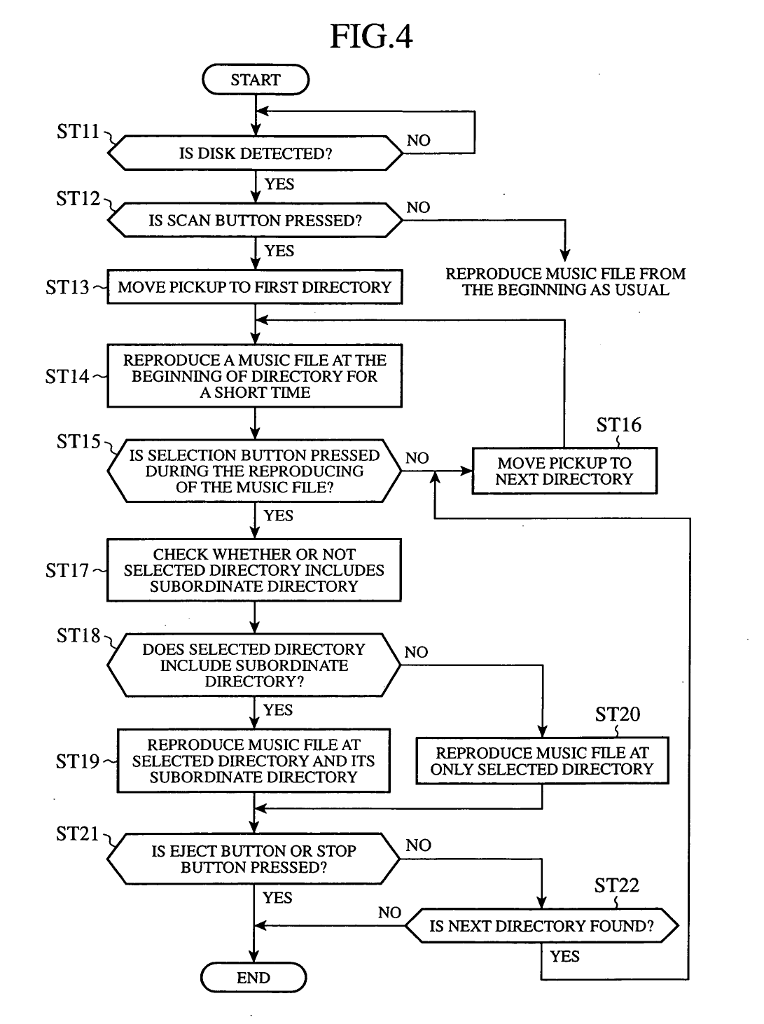

FIG. 1 is a system block diagram to show a disk reproducing device in accordance with embodiment 1 of the present invention. FIG. 2 is a flow chart to show the operation of the disk reproducing device in accordance with embodiment 1 of the present invention. FIG. 3 is an illustration to show a method to scan a hierarchy of directories of embodiment 1 of the present invention. FIG. 4 is a flow chart to show the detailed operation of a reproducing mode of the disk reproducing device in accordance with embodiment 1 of the present invention.

In FIG. 1, an audio set section 1 and a CD deck section 2 are provided and these sections have microprocessors 3, 4 received therein, respectively. The microprocessor 3 as a control means of audio set section 1 includes a communication part 5 for carrying out communication with the CD deck section 2 and a control part 6 for outputting an instruction to the CD deck section 2 side via the communication part 5, a storage part (storage means) 7 for storing information and the like sent back from the CD deck section 2 under control of the control part 6, and a key detecting part 8 which detects that various kinds of outside keys are pressed and informs it to the control part 6. As the various kinds of outside keys for the key detecting part 8 are provided, for example, a SCAN button 11 used to start “scanning search reproduction” mode (which will be described later in detail), a selection button 12 for selecting a directory, an EJECT button 22, and a STOP button 23.

Further, in the audio set section 1 are provided a sound control part 9 for controlling reproduced sound signal from the CD deck section 2 and an amplification part 10 for amplifying output from the CD deck section, and external speakers 13 and 14 are connected to the output side of amplification part 10.

On the other hand, the microprocessor 4 of CD deck section 2 includes a control part 15 and a communication part 16 that is connected to the control part 15 and transmits and receives information to and from the communication part 5 of audio set section 1. Further, in the CD deck section 2 are provided a mechanical part 20 into which a disk 24 is inserted, a disk detecting part (disc detecting means) 17 for detecting that the disk 24 is inserted into this mechanical part 20 and for informing it to the control part 15, a motor driving part 18 for driving a motor (not shown) of the mechanical part 20, and a digital signal processing unit (hereinafter simply referred to as “DSP”) 19 that is connected to the control part 15, the motor driving part 18, a pickup 21 in the mechanical part 20, and the sound control part 9 in the audio set section 1 and performs processing of servo control and signals of the CD deck section 2. Here, the control part 15, the DSP 19 and the pickup 21 of CD deck section 2 and the sound control part 9 and the amplification part 10 of audio set section 1 substantially construct reproducing means.

The control part 15 controls the motor driving part 18 via the DSP 19 to drive the mechanical part 20, and it starts the scanning search reproduction for each directory of the disk 24 which is inserted into the mechanical part 20 when the SCAN button is pressed. And a signal of servo control from the DSP 19 is transmitted through the motor driving part 18 to the mechanical part 20.

Further, the pickup 21 in mechanical part 20 is used as data reading means and data read by the pickup 21 is utilized as “signal for music” and “signal for feedback”.

Still further, sound signal to be reproduced at the time of scanning search reproduction, which will be described later, is captured by the pickup 21 of CD deck section 2 and which is transmitted through the DSP 19, the sound control part 9 and the amplification part 10 in audio set section 1 and then is reproduced by the speakers 13, 14.

Next, operation will be described.

First, the schematic operation of this embodiment will be described with reference to FIG. 2.

The disk 24 in which compressed audio is recorded, is inserted into the mechanical part 20 and then by pressing the SCAN button 11, beginning of the first music file of a directory is found for each directory of the disk 24 and is reproduced for a short time (hereinafter this short time reproduction operation of the first music of a directory is refereed to as “scanning search reproduction”) (step ST1). In the case where the reproduced music file is a music file that a user wants to listen, the user presses the selection button 12. In this embodiment it is explained about a case that these push buttons are provided on the panel surface of audio set section 1, but they may be provided on a remote controller or a handle remote controller.

Next, in the case where the key detecting part 8 of audio set section 1 detects that the selection button 12 is pressed (YES at step ST2), an operating mode of the audio set section 1 is specified as predetermined selection from two kinds of below described operating modes:

1) directory selecting reproduction mode; when a directory in which the selected music file belongs, includes a subordinate directory (YES at step ST3), all the music files which are included the directory and its subordinate directory are normally reproduced (step ST4); normal reproduction of the all music files included in the directory and its subordinate directory, has been completed and then scanning search reproduction is again started (YES at step ST6); in this case, the reason why all the music files included in the directory and its subordinate directory are reproduced, is based on an assumption that the user would intentionally store music files of the same category in the same directory, and

2) artist selecting reproduction mode; all the music files in which the same artist as the selected music file plays, are searched from the whole disk and are reproduced in a predetermined order. This is performed by an arrangement that a music file of MP3 holds information of a so-called ID 3 tag, the information includes the information of name of artist who plays the music in the file and hence all the music files of the selected artist can be searched; here, the ID tag is such that includes information (name of album, year of release, and the like) about a music file in 128 bytes at the bottom of the music file.

At this point when in a case that the selection button is not pressed in the scanning search reproduction mode till all end of the disk 24, the reproduction mode becomes the same as the other mode which is included in the disk reproducing device.

3) all directories selecting reproduction mode; the scanning search reproduction is begun from the first directory and control information about each directory is stored in order during the scanning search reproduction and when the whole control information is stored (when the scanning search reproduction of all the disk 24 has been completed), normal reproducing of music files is started based on a predetermined selection criteria of the control information, for example, alphabetical order of name of music, or sorted date of recording date of the music file).

At this point the audio set section 1 is beforehand decided which mode of above described reproduction mode 1)-3) is selected for the scanning search reproduction mode by user's preference, or alternatively, the audio set section 1 may be brought into a step to be selected at the beginning of initial setup of the audio set section 1 by pressing a button.

Here, scanning, is performed “in order of the level of a hierarchy” or “in order of a path table” as shown in FIG. 3. about a selection of this order the audio set section 1 is beforehand decided which order of above described two is selected for the scanning order by user's preference, or alternatively, the audio set section 1 may be brought into a step to be selected at the beginning of initial setup of the audio set section 1 by pressing a button. In description of this specification, a phrase “reproduction in predetermined order” means that selection of reproduction “in order of the level of a hierarchy” or “in order of a path table” is specified beforehand and reproduction is performed in the specified order.

In FIG. 3, FIG. 3A shows contents of respective levels of a hierarchy of directories. A level 0 is “root” and represents the top level of hierarchical structure and directories A, B of a level 1 are connected to this root. Also directories C, D of a level 2 are connected to the directory A. Directories E, F of a level 3 are connected to the directory C and directory G of the level 3 is connected to the directory D.

Moreover, FIG. 3B shows an order of reproduction in the order of level of the hierarchy and in this case, all directories of a genealogy of one hierarchy is scanned deeply in order of the level of hierarchy and the respective directories are normally reproduced in order of A→C→E→F→D→G→B. Then, FIG. 3C shows an order of reproduction in the order of path table and in this case, the respective levels of hierarchy are scanned for each level in sequence and the respective directories are normally reproduced in order of A→B→C→D→E→F→G.

In a case where a disk has no directory and all the music files are in the “root”, the music file is scanned one by one from the beginning and the reproducing device waits pressing of selection button.

In addition, if genre numbers are recorded in the ID tag 3, music files of the same genre number may be reproduced in place of reproducing music files of the same artist as described above 2) artist selecting reproduction mode based on predetermined selection.

With this arrangement, even a vehicle mounted unit with 1DIN size can reproduce a target music file on a compressed audio basis with relative ease without a careful watch on a display.

In this respect, in a case where user wants to get out from this scanning search reproduction mode, the user uses the EJECT button 12 or the STOP button 23 of the audio set section 1.

In a case where the user wants to reach a target music file without using this scanning search reproduction mode, the user searches the target music file one by one by a use of FOLDER (directory) UP/DOWN key (not shown).

Next, a detailed operation of the 1) directory selecting reproduction mode in this embodiment will be described with reference to FIG. 4.

The disk detecting part 17 detects whether or not the disk 24 is inserted into the mechanical part 20 of CD deck part 2 (step ST11). When an inserting of the disk 24 is detected, it is determined whether or not the SCAN button 11 of audio set section 1 is pressed. In other words, it is determined whether or not an operation mode is the scanning search reproduction mode (step ST12).

When the SCAN button 11 is pressed, the key detecting part 8 provided in the microprocessor 3 of audio set section 1 detects that this SCAN button 11 is pressed. The control part 6 gives an instruction to the control part 15 of microprocessor 4 via the communication part 5 and the communication part 16 in CD deck section 2 on the basis of detection information from the key detecting part 8.

The control part 15 controls the motor driving part 18 via the DSP 19 on the basis of this instruction to drive the mechanical part 20. With this, the scanning search reproduction of disk 24 which is inserted into the mechanical part 20, is started for each directory based in the predetermined order.

At this point, as described above, the DSP 19 performs processing of the servo control and processing of signal of CD deck section 2 and the signal of servo control is transmitted via the motor driving part 18 to the mechanical part 20. Then, the pickup 21 of data reading means is provided in the mechanical part 20 and data read by the pickup 21 is utilized as “signal for music” and “signal for feedback”. Hence, in order to begin the scanning search reproduction of the disk 24 which is inserted into the mechanical part 20 for each directory, the pickup 21 is moved to a position of the first directory (step ST13).

On the other hand, if the SCAN button 11 is not pressed at step ST12, normal reproducing of music files is started from the beginning the disk as usual.

Next, at step ST13, the pickup 21 is moved to the first directory and then a music file at beginning of the directory is normally reproduced for a short time (for example, for 5 seconds) (step ST14). This is the so-called scanning search reproduction operation. The sound signal normally reproduced by this scanning search reproduction operation is captured by the pickup 21 of CD deck section 2 and is transmitted via the DSP 19, the sound control part 9 and the amplification part 10 in the audio set section 1 to the speakers 13, 14 and is reproduced by the speakers 13, 14.

Next, it is determined whether or not the selection button 12 is pressed during the normal reproducing of sound signal at step ST14 (step ST15). If it is detected that the selection button 12 is pressed, that is, a selection mode is performed, it is determined whether or not the directory which is selected during the normal reproducing of sound signal includes any subordinate directory (step ST17). Thereafter, if the selected directory includes some subordinate directory (YES at step ST18), all music files (music) of the selected directory and its subordinate directory are reproduced (step ST19).

On the other hand, if the selection button 12 is not pressed at step ST15, the routine proceeds to step ST16 where the pickup 21 is moved to next directory. Then, the routine proceeds to step ST14 where a music file at a beginning of the directory is reproduced for a short time.

In a case where the selected directory does not include any subordinate directory at step ST18, all the music files (music) of only the selected directory are reproduced (step ST20).

It is determined during or after the reproducing of music file at steps ST19, ST20 whether or not the EJECT button 22 or the STOP button 23 is pressed (step ST21) and if the EJECT button 22 or the STOP button 23 is pressed, a series of operations for scanning search reproduction are finished.

On the other hand, if the EJECT button 22 or the STOP button 23 is not pressed at step ST21, scanning search reproduction is continued and hence it is checked whether or not there is the next directory in the predetermined order of the level of hierarchy or order of the path table (step ST22). If the next directory is found at step ST22, the routine proceeds to step ST16 where the pickup 21 is moved to the next directory and then returns to step ST14 where a music file at a beginning of the directory is reproduced for a short time, in other words, scanning search reproduction is repeated.

On the other hand, if the next directory is not found at step ST22, the operation of scanning search reproduction is automatically finished.

At this point, the control part 15 of microprocessor 4 of CD deck section 2 reads the name of directory of a music file whose beginning is now reproduced as control information through the pickup 21. The read control information is sent back to the microprocessor 3 of audio set section 1. If necessary, the information in ID3 tag (corresponding to 128 bytes at the bottom of music file; in the case of ID3 tag, the head portion of 128 bytes becomes a letter of “TAG”) is read as the control information and is sent back in a like manner to the microprocessor 3 of audio set section 1.

The microprocessor 3 of audio set section 1 temporarily stores the returned control information sent back in the storage part 7 in order to prepare for 3) all directories selecting reproduction mode when the selection button 12 is not pressed at all during the scanning search reproduction. And when the selection button 12 is pressed during the scanning search reproduction, the microprocessor 3 again instructs the microprocessor 4 of CD deck section 2 to reproduce all the music file (music) of the selected directory and its subordinate directories.

As described above, according to this embodiment 1, at the time of reproducing the disk conforming to the compressed audio file system such as MP3 and WMA, the first music file of each directory is scanned and a part of the music file is normally reproduced for short time and when the user presses the selection button, all the music file (music) of selected directory are reproduced (directory selecting reproduction mode) or the music files which is played by the same artist as the selected music file are selected and reproduced (artist selecting reproduction mode) . Hence, even in a case of the vehicle mounted unit with 1DIN size, the user can reproduce a target music file on compressed audio basis by a simple operation with relative ease and speedily without a careful watch on a display. In the embodiment, an explanation has been made for a case where data having a hierarchical structure of directories in the disk is compressed audio, but needless to say, the data may be image data accompanied by music.

1. A disk reproducing device comprising:
disk detecting means that detects whether or not a disk which stores music data stored in a plurality of directories formed in a hierarchical structure is inserted into a deck section;
control means that determines whether or not an operation mode is a scanning search reproduction mode and generates an instruction to start scanning search reproduction of the disk inserted into the deck section for each directory when the operation mode is the scanning search reproduction mode; and
reproducing means that selects a directory from the disk on a basis of instruction from the control means and normally reproduces a music file at the beginning of the directory for a short time.

2. The disk reproducing device as claimed in claim 1, wherein the reproducing means determines whether or not the directory selected during the normal reproducing of the music file has a subordinate directory and if the directory selected during the normal reproducing of the music file has the subordinate directory, normally reproduces all the music files in the selected directory and its subordinate directory and if the directory selected during the reproducing of the music file does not have the subordinate directory, normally reproduces all the music files in the only selected directory.

3. The disk reproducing device as claimed in claim 1, wherein the control means has storage parts and wherein the reproducing means continues selection of the directory from the disk to the end of the disk and makes the storage means store control information in succession during a selection mode and starts normal reproducing of the music based on a predetermined criterion used the control information from the control means at the time when the storage means stores all information.

4. The disk reproducing device as claimed in claim 1, wherein the reproducing means searches music files which are played by the artist of selected music file from the whole disk and normally reproduces the music files in the predetermined order.
